(19) United States
(12) Patent Application Publication
(10) Pub. No.: US 2014/0170763 A1
(43) Pub. Date: Jun. 19, 2014

(54) Processes for Determining Stream Compositions in Simulated Moving Bed Systems

(71) Applicant: UOP LLC, Des Plaines, IL (US)

(72) Inventors: Chad A. Williams, Chicago, IL (US); Bruce R. Beadle, Kildeer, IL (US); Heather A. Fleitz, Chicago, IL (US); Edwin M. Victor, Arlington Heights, IL (US); Gregory A. Ernst, Oak Park, IL (US)

(73) Assignee: UOP LLC, Des Plaines, IL (US)

(21) Appl. No.: 13/714,831

(22) Filed: Dec. 14, 2012

(51) Int. Cl. G01N 21/65

(52) U.S. Cl. CPC G01N 21/65
USPC 436/140

(57) ABSTRACT

Processes for simulated moving bed systems for separating a preferentially adsorbed component from a feed stream and processes for determining compositions of one or more streams in the system are provided. The process comprises the steps of rotating a rotary valve to a first valve position to direct the feed stream to a first adsorbent sub-bed. A process stream is irradiated with laser light that is directed from a probe of a Raman system positioned for inline sampling of the stream. Scattered light from the irradiated stream is collected with the probe and analyzed to assess concentrations of one or more components in the stream.

### FIELD OF THE INVENTION

The present invention relates generally to processes for separating a preferentially adsorbed component from a mixture of other components using simulated moving bed systems, and more particularly relates to determining the composition of streams of the simulated moving bed systems.

### BACKGROUND OF THE INVENTION

Continuous separation processes are commonly used for the selective adsorption of para-xylene from a mixture of C₈ aromatics. Generally, these processes use a solid adsorbent that preferably retains the para-xylene in order to separate the para-xylene from the rest of the mixture. Often, these systems include a simulated moving bed system, where beds of the solid adsorbent are held stationary, and the locations at which the various process streams enter and leave the beds, or chambers holding the beds, are periodically moved. The adsorbent bed itself is usually a succession of fixed sub-beds within one or more adsorption separation chambers. The shift in the locations of the fluid input and output in the direction of the fluid flow through the bed simulates the movement of the solid adsorbent in the opposite direction. In one such process, the movement of the locations of the fluid input and output is accomplished by a fluid tracking device known generally as a rotary valve, which works in conjunction with distributor lines located between the adsorbent sub-beds. The rotary valve accomplishes moving the input and output locations through first directing the liquid introduction or withdrawal lines to specific distributors located between the adsorbent sub-beds. After a specified time period, called the step time or hold period, the rotary valve advances one index to the next valve position and redirects the liquid inputs and outputs to the distributors immediately adjacent and downstream of the previously used distributors. Each advancement of the rotary valve to the next valve position is generally called a valve step, and the completion of all the valve steps is called a valve cycle. In one commercial process, the step time is uniform for each of the valve steps in a valve cycle, and is generally about 60 seconds or so. A typical process contains 24 adsorbent sub-beds, 24 distributors located between the 24 adsorbent sub-beds, two liquid input lines, two liquid output lines, and flush lines for removing residual fluid from fluid transfer lines to restrict contamination between the different input and output fluids.

The principle liquid inputs and outputs of the adsorbent system consist of four streams, which include the feed, the extract, the raffinate, and the desorbent. The feed, which is introduced to the adsorbent system, contains the para-xylene, or other component, that is to be separated from the other components in the feed stream. The desorbent, which is introduced to the adsorbent system, contains a liquid capable of displacing feed components from the adsorbent. The extract, which is withdrawn from the adsorbent system, contains the separated para-xylene, which was selectively adsorbed by the adsorbent, and the desorbent liquid. The raffinate, which is withdrawn from the adsorbent system, contains other C₈ aromatic components of the feed that are less selectively adsorbed by the adsorbent, and desorbent liquid. The four primary streams are provided to or from the adsorbent chambers via transfer lines between the rotary valve and the adsorbent chamber distributors. There also may be associated flush streams introduced to and withdrawn from the adsorbent chamber via the transfer lines. The fluids are provided to the transfer lines through corresponding ports of the rotary valve. Crossover lines provide fluid communication between tracklines of the rotary valve and the ports. The streams are provided to and from the rotary valve tracklines via net streams which run between track lines of the rotary valve and other portions of the separation system or the larger complex.

The four principal streams are spaced strategically throughout the adsorbent system and divide the sub-beds into four zones, each of which performs a different function. Zone I contains the adsorbent sub-beds located between the feed input and the raffinate output, and the selective adsorption of the para-xylene takes place in this zone. Zone II contains the adsorbent sub-beds located between the extract output and the feed input, and the desorption of components other than the para-xylene takes place in this zone. Zone III contains the adsorbent sub-beds located between the desorbent input and the extract output, and the para-xylene is desorbed in this zone. Finally, Zone IV contains the adsorbent sub-beds located between the raffinate output and the desorbent input. The purpose of zone IV is to prevent the contamination of the para-xylene with other components.

A common practice in the industry is to determine the compositional profile of the para-xylene simulated moving bed separation process either by on-line gas chromatography analysis, or by off-line laboratory analysis. The on-line gas chromatography analysis typically requires about 10 minutes per analysis, which is considerably greater than the usual step time of the rotary valve. Therefore, only selected valve positions can be sampled and analyzed. Generally, only Zone II near the extract output and Zone IV near the desorbent input are sampled and analyzed. The data provided by this on-line gas chromatography procedure is useful for detecting some process upsets, but unfortunately analyzing the composition of only two valve positions provides limited information regarding the performance of the separation process and is only minimally useful for precise separation process control.

A more thorough determination of the compositional profile of the para-xylene simulated moving bed separation process is accomplished using off-line laboratory gas chromatography analysis to determine the values of the concentrations of the components in the samples for each valve position in a valve cycle. The measured concentrations are then plotted versus their relative valve positions to form what is generally called a pump-around profile. Using the pump-around profile, the recovery purity of the para-xylene can be calculated and the degree of optimization of the separation may be assessed. From this, for example, needed changes in the step time and/or liquid stream flow rates may be determined and implemented. The drawbacks to assessing the separation process in this fashion are the time delay between sampling and delivery of the analytical results, where the latter are used to determine whether or what process changes should be made; the labor involved to manually collect the stream samples; and the personal exposure of the operator manually collecting the stream samples from the process. Since the analysis is performed off-line, the time delay may be from one to several days long and can lead to plant disruption. Because of these drawbacks, refiners generally only perform this procedure about once every six months or if there is a problem with the separation process.

Co-owned pending U.S. patent application Ser. No. 13/676,778, discloses a system and method that utilizes a Raman system to irradiate an intermediate stream between two adsorbent sub-beds of a simulated moving bed system. The Raman system collects scattered light of the irradiated stream to generate a spectrum of the scattered light and to assess concentrations of para-xylene and one or more other components of the system. The application discloses that this can be done during a full cycle of the simulated moving bed system to provide a more accurate and current compositional profile of the fluid within the adsorbent beds. The compositional information may then be used to identify upsets in the system and adjustments may be made to operational parameters in order to optimize the process.

It has been identified that contamination of the primary streams as well as the flush streams, for example, in tracklines of a rotary valve, may also be responsible for disrupting the compositional profile and/or causing the product to go off-specification. Contamination of the primary and flush streams may occur for a variety of reasons; however, one reason may include leaking of process fluids between the streams as they are transferred through the rotary valve. For example, due to the high fluid pressures within the tracklines of the rotary valve, the seal sheet covering the tracklines may deflect, allowing a small amount of fluid to pass between tracklines. Because industry standards require a very pure para-xylene product (above 99%), even small leaks between the tracklines may result in the product going off-specification. However, due to the complexity of the rotary valve, it has been difficult to determine whether product impurities are caused by leaks between process streams in the rotary valve, and to identify the particular source of contamination between the streams in the rotary valve, even after stopping the operation and disassembling the rotary valve.

Accordingly, it is desirable to provide systems for the separation of para-xylene from other hydrocarbon components and processes for determining concentrations of one or more components in the trackline streams to facilitate identifying the presence and cause of contaminants within process streams, including the tracklines of the rotary valve in order to maintain product purity and minimize downtime of the separation processes.

### SUMMARY OF THE INVENTION

Processes for determining a composition of a process stream in a simulated moving bed system using a Raman system are provided. In one approach, the process includes determining a composition of a trackline stream of the rotary valve in a system having a plurality of adsorbent sub-beds in fluid communication with each other and with the rotary valve. The process according to this approach includes rotating the rotary valve to a first valve position to direct the feed stream to a first adsorbent sub-bed of the plurality of sub beds. The process further includes irradiating a trackline stream of the rotary valve with laser light that is directed from a probe of a Raman system positioned for inline sampling of the trackline stream. The scattered light is collected from the irradiated trackline stream with the probe and analyzed with the Raman system to assess concentrations of one or more components in the trackline stream.

In another approach, the process includes determining a composition of a net stream of a rotary valve in a simulated moving bed system having a plurality of adsorbent sub-beds in fluid communication with each other and with the rotary valve for separating one or more preferentially adsorbed components from a feed stream. The process according to this approach includes rotating the rotary valve to a first valve position to direct the feed stream to a first adsorbent sub-bed of the plurality of adsorbent sub-beds. The process further includes irradiating a net stream in fluid communication with a trackline stream of the rotary valve with laser light that is directed from a probe of a Raman system positioned for inline sampling of the net stream. The scattered light is collected from the irradiated net stream with the probe and analyzed with the Raman system to assess concentrations of one or more components in the net stream.

### BRIEF DESCRIPTION OF THE DRAWINGS

FIG. 1 illustrates a simulated moving bed system in accordance with various embodiments;

FIG. 2 illustrates a perspective view of a portion of a rotary valve in accordance with various embodiments; and

FIG. 3 illustrates a compositional profile of an adsorption separation chamber in accordance with various embodiments.

### DETAILED DESCRIPTION

Adsorptive separation is applied to the recovery of a variety of hydrocarbon and other chemical products. Chemical separations using this approach which have been disclosed include the separation of mixtures of aromatics into specific aromatic isomers, of linear from nonlinear aliphatic and olefinic hydrocarbons, of either paraffins or aromatics from a feed mixture comprising both aromatics and paraffins, of chiral compounds for use in pharmaceuticals and fine chemicals, of oxygenates such as alcohols and ethers, and of carbohydrates such as sugars. Aromatics separations include mixtures of dialkyl-substituted monocyclic aromatics and of dimethyl naphthalenes. A major commercial application, which forms the focus of the prior references and of the following description of the present invention, without so limiting it, is the recovery of para-xylene and/or meta-xylene from mixtures of C₈ aromatics.

An adsorptive separation process simulates countercurrent movement of the adsorbent and surrounding liquid as described above, but it may also be practiced in a concurrent continuous process, like that disclosed in U.S. Pat. Nos. 4,402,832 and 4,478,721. Processes for separating components of a feed stream are discussed in Chapter 10.3 of the Handbook of Petroleum Refining Processes, 2d Edition at pages 10.45-10.81, which is incorporated by reference herein.

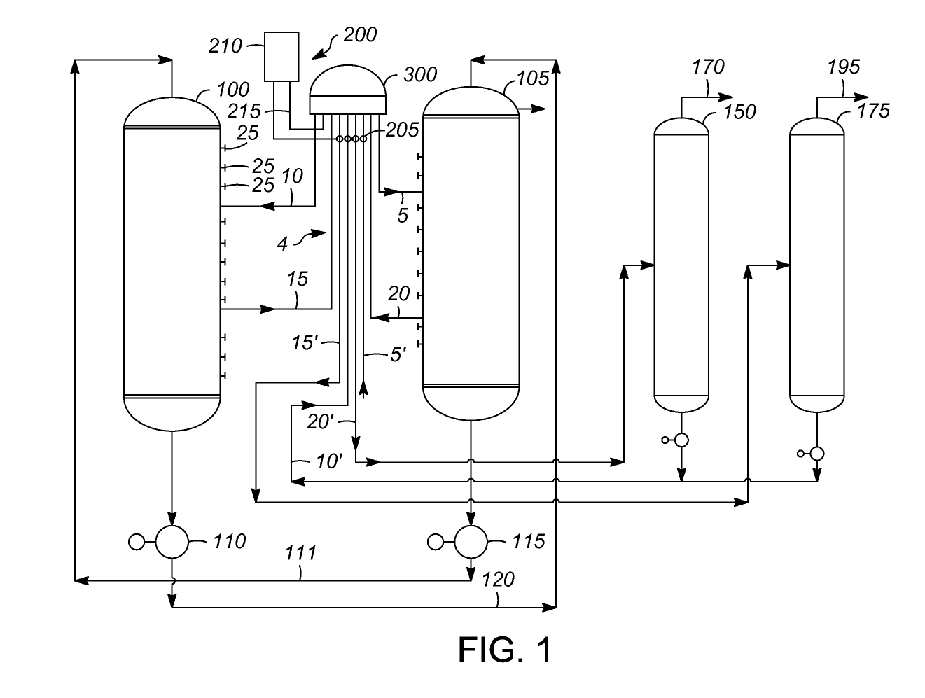

FIG. 1 is a schematic diagram of a simulated-moving-bed adsorption separation system and process in accordance with one aspect. The process sequentially contacts a feed stream 5 with adsorbent contained in the vessels and a desorbent stream 10 to separate an extract stream 15 and a raffinate stream 20. In the simulated-moving-bed countercurrent flow system, progressive shifting of multiple liquid feed and product access points or ports 25 down an adsorbent chamber 100 and 105 simulate the upward movement of adsorbent contained in the chamber. The adsorbent in a simulated-moving-bed adsorption process is contained in multiple beds in one or more vessels or chambers; two chambers 100 and 105 in series are shown in FIG. 1, although a single chamber or other numbers of chambers in series may be used. Each vessel 100 and 105 contains multiple beds of adsorbent in processing spaces. Each of the vessels has a number of ports 25 relating to the number of beds of adsorbent, and the position of the feed stream 5, desorbent stream 10, extract stream 15 and raffinate stream 20 are shifted along the ports 25 to simulate a moving adsorbent bed. Circulating liquid comprising feed, desorbent, extract and raffinate circulates through the chambers through pumps 110 and 115, respectively. Fluid is passed from bottom of the first chamber to the top of the second chamber 105 via pusharound line 120 and from the bottom of the second chamber 105 to the top of the first chamber 100 via pumparound line 111. Systems to control the flow of circulating liquid are described in U.S. Pat. No. 5,595,665, but the particulars of such systems are not essential to the present invention. A rotary disc type valve 300, as characterized for example in U.S. Pat. No. 3,040,777 and U.S. Pat. No. 3,422,848, which are incorporated by reference herein in their entirety, effects the shifting of the streams along the adsorbent chamber to simulate countercurrent flow.

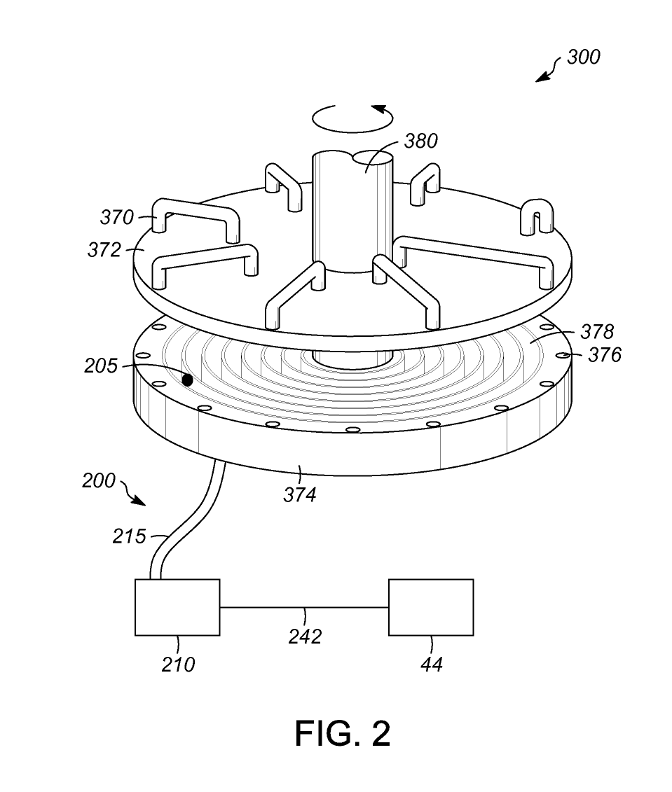

Referring to FIG. 2, a simplified exploded diagram of an exemplary rotary valve 300 for use in an adsorptive separation system and process is depicted. A base plate 374 includes a number of ports 376. The number of ports 376 equals the total number of transfer lines on the chamber(s). The base plate 374 also includes a number of tracklines 378. By one aspect, the number of tracklines 378 equals the number of net streams 4 to and from the rotary valve 300, including input, output, and flush lines for the adsorptive separation unit. The rotary valve 300 in FIG. 2 is illustrated with eight tracklines, which corresponds to eight net streams 4, e.g., four primary streams and four flush streams (not illustrated in FIG. 1). The net streams 4, including the inputs, outputs, and flush lines, are each in fluid communication with a dedicated trackline 378. Crossover lines 370 place a given trackline 378 in fluid communication with a given port 376. Referring back to FIG. 1, in one example, the net inputs include a feed input 5′ and a desorbent input 10′, the net outputs include an extract output 15′ and a raffinate output 20′, and the flush lines include between about one and about four flush lines. As the rotor 380 rotates as indicated each track 378 is placed in fluid communication with the next successive port 376 by crossover line 370. A seal sheet 372 is also provided to cover the tracklines and may include a bottom surface configured to seal the tracklines.

The various streams involved in simulated-moving-bed adsorption as illustrated in the figures and discussed further below with regard to the various aspects of the invention described herein may be characterized as follows. A “feed stream” is a mixture containing one or more extract components or preferentially adsorbed components and one or more raffinate components or non-preferentially adsorbed components to be separated by the process. The “extract stream” comprises the extract component, usually the desired product, which is more selectively or preferentially adsorbed by the adsorbent. The “raffinate stream” comprises one or more raffinate components which are less selectively adsorbed or non-preferentially adsorbed. “Desorbent” refers to a material capable of desorbing an extract component, which generally is inert to the components of the feed stream and easily separable from both the extract and the raffinate, for example, via distillation.

The extract stream 15 and raffinate stream 20 from the illustrated schemes contain desorbent in concentrations relative to the respective product from the process of between 0% and 100%, more likely between about 40 and about 60%. The desorbent generally is separated from raffinate and extract components by conventional fractionation in, respectively, raffinate column 150 and extract column 175 as illustrated in FIG. 1 and may be recycled to the process. The raffinate product 170 and extract product 195 from the process are recovered from the raffinate stream and the extract stream in the respective columns 150 and 175; the extract product 195 from the separation of C8 aromatics usually comprises principally one of para-xylene and meta-xylene, with the raffinate product 170 being principally non-adsorbed C8 aromatics and ethylbenzene.

The liquid streams, e.g., the streams of feed 5, desorbent 10, raffinate 20, and extract 15 entering and leaving the adsorbent chambers 100 and 105 via the active liquid access points or ports 25 effectively divide the adsorbent chamber 100 and 105 into separate zones which move as the streams are shifted along the ports 25. It should be noted that while much of the discussion herein refers to FIG. 1 and the location of the streams in FIG. 1, FIG. 1 illustrates only a current location of the streams at a single step or a snapshot of the process as the streams typically shift downstream at different steps of a cycle. As the streams shift downstream, the fluid composition and the corresponding zones shift downstream therewith. According to one example, the streams are stepped simultaneously to subsequent ports 25 by rotating the rotary valve 300, and are maintained at a particular port 25 or step for a predetermined step-time interval. In one approach, there are between about 4 and 100 ports 25, between about 12 and 48 ports in another approach, and between about 20 and 30 ports in yet another approach, and an equal number of corresponding transfer lines. In one preferred form, there are 24 ports 25.

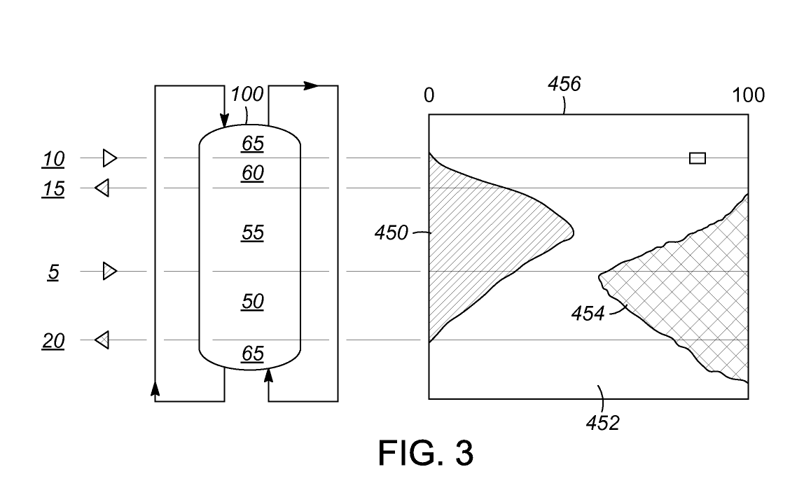

With this in mind, FIG. 3 illustrates a snapshot of the compositional profile of the fluid within an adsorptive separation chamber (a single adsorptive separation chamber 100 is illustrated in FIG. 3 for ease of explanation) and the corresponding zones into which the adsorptive separation chamber 100 is divided. The adsorption zone 50 is located between the feed inlet stream 5 and the raffinate outlet stream 20. In this zone, the feed stream 5 contacts the adsorbent, an extract component is adsorbed, and a raffinate stream 20 is withdrawn. As illustrated in the figure, the raffinate stream 20 may be withdrawn at a location where the composition includes raffinate fluid 454 and little if any extract fluid 450. Immediately upstream with respect to fluid flow is the purification zone 55, defined as the adsorbent between the extract outlet stream 15 and the feed inlet stream 5. In the purification zone 55, the raffinate component is displaced from the nonselective void volume of the adsorbent and desorbed from the pore volume or surface of adsorbent shifting into this zone by passing a portion of extract stream material leaving the desorption zone 60. The desorption zone 60, upstream of the purification zone 55, is defined as the adsorbent between the desorbent stream 10 and the extract stream 15. The desorbent passing into this zone displaces the extract component which was adsorbed by previous contact with feed in the adsorption zone 50. The extract stream 15 may be withdrawn at a location of the chamber 100 that includes extract fluid 450 and little if any raffinate fluid 454. A buffer zone 65 between the raffinate outlet stream 20 and the desorbent inlet stream 10 prevents contamination of the extract, in that a portion of the desorbent stream enters the buffer zone to displace raffinate material present in that zone back into the adsorption zone 50. The buffer zone 65 contains enough adsorbent to prevent raffinate components from passing into the desorption zone 60 and contaminating the extract stream 15.

In this manner, during typical operation of the system, the trackline and net streams for the four primary streams should typically be similar no matter where along the cycle the rotary valve 300 is currently positioned. The feed stream in both the trackline 378 and the net feed line 5′ typically includes a mixture of para-xylene and other C₈ aromatics, and can potentially include other components as well. The desorbent stream in both the trackline 378 and the net desorbent line 10′ typically includes primarily desorbent, but may also include small amounts of C₈ and C₉ aromatics. The extract stream in the trackline 378 and the net extract line 15′ is typically expected to include primarily para-xylene and desorbent and should include only small or trace amounts of remaining additional C₈ aromatics (e.g., below about 1% in one example, below about 0.5% in another example, and below about 0.1% in yet another example). The raffinate stream in the trackline 378 and the net raffinate line 20′ is typically expected to include primarily other C₈ aromatics and desorbent and should include only small or trace amounts of remaining para-xylene.

Various aspects contemplated herein relate to simulated moving bed systems for separating one or more components from a feed stream. One aspect relates to the separation of a desired component from a feed stream containing a hydrocarbon mixture and processes for determining a composition of a trackline stream of the simulated moving bed systems. Another aspect relates to the separation of para-xylene from a feed stream containing a hydrocarbon mixture and processes for determining a composition of a trackline stream of the simulated moving bed system. The simulated moving bed system has a plurality of adsorbent sub-beds in fluid communication with each other and with a rotary valve for separating a preferentially adsorbed component from one or more non-preferentially adsorbed components of the feed stream, for example the separation of para-xylene from the feed stream comprising para-xylene and one or more other C₈ aromatics.

By one aspect, a Raman system 200 is provided for irradiating a stream of the adsorption separation system with laser light from a probe 205 of the Raman system 200 positioned for inline sampling of the stream. The process includes collecting scattered light from the irradiated stream with the same or another Raman probe 205. Finally, the process includes analyzing the scattered light with the Raman system 200 to assess concentrations of one or more components in the stream. In one approach, the stream includes a trackline stream 278 of the rotary valve 300. In another approach, the stream includes a net stream 4 provided to or from the Rotary valve 300. In yet another approach, the stream may include two or more streams and may also include an intermediate stream, such as pusharound stream in line 120 or pumparound stream in line 111.

Turning to more of the particulars, the Raman system 200 includes at least one probe 205 operatively coupled to a Raman spectrophotometer 210, by, for example, an optical fiber optic cable or cables 215. Without interrupting, or altering the volume of, the stream of the simulated moving bed system, the probe 205 is positioned for inline sampling of the stream. In an exemplary embodiment, the Raman system 200 includes a computer 244 operatively interfacing with the Raman spectrophotometer 210. In one approach, a controller may operatively interface with the rotary valve 300 and the computer 244. In one approach, in response to the rotary valve 300 rotating an index to a particular valve position to reposition the feed stream, the controller generates a signal to the computer which triggers the Raman system to begin analyzing the stream. In another approach, the Raman system intermittently analyzes the stream without depending on the rotary valve indexing. Where the rotary valve 300 rotating an index initiates analyzing the stream, the stream may be used to determine a profile of the adsorbent separation chamber and/or the composition of a trackline or net stream for each valve position. The position of the rotary valve 300 may be useful if contamination is identified in one of the trackline stream or a net stream as it may indicate that the contamination is isolated to a particular transfer line or portion of one of the adsorption separation chambers 100 or 105, rather than, for example, a leak between one or more tracklines 278.

The Raman system 200 includes a Raman spectrophotometer 210 that is coupled to the probe 205 by a fiber optic cable 215. The Raman spectrophotometer 210 is configured to generate laser light in the visible, near infrared, or near ultraviolet range that is advanced through the fiber optic cable 210 and directed into the intermediate stream by the probe 205. In a preferred embodiment, the Raman spectrophotometer 210 generates laser light having a wavelength of about 785 nm. The probe 205 is configured to collect the scattered light from the irradiated stream as the molecules in the stream begin to relax. The scattered light is returned to the Raman spectrophotometer 200 through the fiber optic cable 215. The Raman spectrophotometer 210 is also configured to generate a spectrum of the scattered light that represents a compositional fingerprint of the intermediate stream. One such suitable Raman spectrophotometer 210 is the Kaiser Optical Raman RXN4 spectrophotometer which is manufactured by Kaiser Optical Systems Inc. located in Ann Arbor, Mich.

The stream is irradiated with laser light directed from the probe preferably in the visible, near infrared, or near ultraviolet range, and most preferably in the near infrared due to fewer issues with fluorescence. In one example, the Raman spectrophotometer is configured to have variation in laser light intensity of about +/−5%, and more preferably of about +/−3% or less. The laser light impinges upon and excites molecules of the components in the intermediate stream from their ground state to a virtual energy state. When the molecules begin to relax, they emit photons and return to a different rotational or vibrational state. The difference in energy between the original state and the new state leads to a shift in the emitted photons' frequencies away from the excitation wavelength. This emitted light, which is referred to as scattered light and is characteristic of the composition of the intermediate stream, is collected by the probe. The Raman system 200 generates a spectrum of the scattered light. An algorithm that correlates the concentrations of the components to the spectrum is preferably used to analyze the spectrum and to calculate the concentrations of one or more components present in the stream. Depending on the stream being analyzed, the stream may contain various amounts of para-xylene and/or other preferably adsorbed components, desorbent, or one or more other components, including, for example, one or more other C₈ aromatics from the feed stream, so that the spectrum may be a composite of all of the components present in the stream. For example, in a para-xylene separation process, if the extract trackline stream or extract net stream is analyzed, it would be expected to include primarily para-xylene and desorbent. If the Raman spectrophotometer indicated that high levels of other C₈ aromatics, or excessive levels of desorbent, were present in one of these streams, these would be considered to be undesirable or contaminants. Similarly, the raffinate trackline stream or raffinate net stream would be expected to include other C₈ aromatics and desorbent. If high levels of para-xylene, or excessive levels of desorbent, were present in the stream, it would be considered to be undesirable or to include a contaminant.

In this regard, by one approach, the method includes analyzing the concentration of one or more components in the stream to determine whether a contaminant is present in the stream. By one aspect, the concentration of one or more un-desired components may be determined using the Raman system. The amount of the un-desired component may then be compared to a predetermined threshold level for that component. If the measured amount of the component exceeds the predetermined threshold level, a determination is made that a contaminated level of the component is present. On the other hand, by one aspect, the concentration of one or more desired components may be determined using the Raman system 200. The amount of the desired component may then be compared to a predetermined threshold level for that component. If the measured amount of the component falls below the predetermined threshold level, a determination is made that the stream is contaminated with another component.

In one approach, the Raman spectrophotometer 210 in combination with a controller, computer and the algorithm are used to automatically generate and graphically represent the concentrations of each of the components in the stream. This process may run continuously to provide rapid and frequent analytical results. Furthermore, the process can be fully automated requiring little or no maintenance and essentially no operator time and labor. Moreover, the probe is positioned for inline sampling of the stream to provide information similar to the manual sampling procedure but without increasing the process stream volume or disrupting production.

As illustrated in FIG. 2, the Raman system 200 is coupled by line 242 to a computer 244. In an exemplary embodiment, an algorithm installed in the spectrophotometer software is executed on the computer 244. The algorithm correlates the concentrations of the components in the stream to the spectrum generated by the Raman system 200.

After the Raman system 200 is directed to begin scanning, the concentrations of components in the streams, e.g. the para-xylene, other C₈ aromatics, and/or desorbent, in the stream are measured using the probe 205. First, the Raman spectrophotometer 210 acquires a dark scan, which essentially determines the number of counts the CCD array of the Raman spectrophotometer 210 produces when the Raman spectrophotometer's shutter is closed and the detector is seeing nothing. This step, however, does not need to be preformed for each scan or even in response to the trigger signal, and therefore, can be performed occasionally and/or during a time other than the profile time. Then, the Raman system 210 irradiates the stream with the laser light and collects the scattered light. The Raman spectrophotometer 210 generates a spectrum, preferably through a series of acquisition and accumulation steps of irradiating the stream and collecting the scattered light that is then electronically communicated via line 242 to the computer 244. The computer 244, using the algorithm, analyzes the spectrum to determine the concentrations for each of the components.

In one approach, after the completion of the first step time, the entire process may be repeated again for each of the valve positions of the rotary valve 25 to determine the concentrations of each of the components for each of the valve positions. The concentrations for the components, e.g., para-xylene, meta-xylene, ortho-xylene, ethylbenzene, and the desorbent, typically para-diethylbenzene, at each of the 24 valve positions can be graphically represented as weight percent versus valve position.

As mentioned previously, one or more streams within the system may be analyzed, including, but not limited to trackline streams 378 of the rotary valve 300, net streams to or from the rotary valve 300, and intermediate streams between adsorbent beds, such as pusharound line 120 stream and pumparound line 111 stream. Where more than one of the streams is analyzed, the compositions of the streams can be analyzed together or compared to identify a source of contamination. For example, if a level of a component in one trackline stream is above a predetermined threshold level, or an expected level, indicating a contaminated level, and the level of the component in another trackline stream is below an expected level, it may indicate that a leak is present between the two streams.

By one aspect, where the Raman probe is positioned for inline sampling of a trackline stream 378, the Raman probe may be positioned at a bottom portion of the trackline stream 378 to provide access to the trackline stream 378. According to various aspects, it may be desirable to include the Raman probe 205 at a position along the trackline where a delta P (ΔP) has previously been determined to be at a relatively high level. This may be beneficial because leaks between adjacent tracklines can be expected to be more likely to occur if there is a higher ΔP between the tracks. In one example, the Raman probe 205 is located at a position along the trackline where the ΔP is determined to be above 75% of a maximum ΔP along the trackline, above about 85% of a maximum ΔP along the trackline in another example, and above about 90% of maximum ΔP along the trackline in yet another example.

Similarly, the Raman probe may be positioned within the trackline at a location where a relatively large amount of seal sheet deflection has been identified. This may be advantageous, because it has been identified that these deflections may contribute to leaks between tracklines in the rotary valve 300. In one example, the Raman probe 205 may be positioned at a location along the trackline where above 75% of a maximum deflection has been observed, above about 85% in another example, and above 90% in yet another example.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

1. A process for determining a composition of a trackline stream of a rotary valve in a simulated moving bed system having a plurality of adsorbent sub-beds in fluid communication with each other and with the rotary valve for separating one or more preferentially adsorbed components from a feed stream comprising the preferentially adsorbed component and one or more other non-preferentially adsorbed components, the process comprising the steps of:
rotating the rotary valve to a first valve position to direct the feed stream to a first adsorbent sub-bed of the plurality of adsorbent sub-beds;
irradiating a trackline stream of the rotary valve with laser light that is directed from a probe of a Raman system positioned for inline sampling of the trackline stream;
collecting scattered light from the irradiated trackline stream with the probe; and
analyzing the scattered light with the Raman system to assess concentrations of one or more components in the trackline stream.

2. The process of claim 1, wherein the probe of the Raman system is positioned near a bottom portion of the trackline.

3. The process of claim 1, wherein the probe of the Raman system is positioned at a location along the trackline at having a ΔP that is at least 75% of a maximum ΔP within the trackline.

4. The process of claim 1, wherein the probe of the Raman system is positioned at a location where deflection of a seal sheet of the rotary valve has previously been identified as being at least about 75% of a maximum seal sheet deflection.

5. The process of claim 1, further comprising determining whether the concentration of the one or more components indicates the presence of a contaminant in the trackline stream.

6. The process of claim 5, wherein determining whether the concentration of the one or more components indicates the presence of a contaminant in the trackline stream includes determining whether the concentration of one or more components is above a predetermined threshold level.

7. The process of claim 5, wherein determining whether the concentration of the one or more components indicates the presence of a contaminant in the trackline stream includes determining whether the concentration of one or more components is below a predetermined threshold level.

8. The process of claim 1, further comprising irradiating another trackline stream of the rotary valve with laser light that is directed from another probe of the Raman system positioned for inline sampling of the trackline stream;
collecting scattered light from the irradiated other trackline stream with the other probe;
analyzing the scattered light with the Raman system to assess concentrations of one or more components in the other trackline stream; and
analyzing both the concentrations of the one or more components in the trackline stream and the concentrations of one or more of the same or other components in the other trackline stream to identify a source of contamination.

9. The process of claim 1, further comprising irradiating at least one of a pusharound stream and a pumparound stream between a bottom of an adsorption separation chamber and a top of at least one of the same or another adsorption separation chamber of the simulated moving bed system with laser light that is directed from another probe of the Raman system positioned for inline sampling of the at least one of the pusharound stream and the pumparound stream;
collecting scattered light from the irradiated at least one of the pusharound stream and the pumparound stream with the other probe; and
analyzing the scattered light with the Raman system to assess concentrations of one or more components in the at least one of the pusharound stream and the pumparound stream.

10. The process according to claim 1, wherein the concentration of the one or more components is determined by generating a spectrum and determining the concentrations of the one or more components according to an algorithm correlating the concentrations to the spectrum.

11. A process for determining a composition of a net stream of a rotary valve in a simulated moving bed system having a plurality of adsorbent sub-beds in fluid communication with each other and with the rotary valve for separating one or more preferentially adsorbed components from a feed stream comprising the preferentially adsorbed component and one or more other non-preferentially adsorbed components, the process comprising the steps of:
rotating the rotary valve to a first valve position to direct the feed stream to a first adsorbent sub-bed of the plurality of adsorbent sub-beds;
irradiating a net stream in fluid communication with a trackline stream of the rotary valve with laser light that is directed from a probe of a Raman system positioned for inline sampling of the net stream;
collecting scattered light from the irradiated net stream with the probe; and
analyzing the scattered light with the Raman system to assess concentrations of one or more components in the net stream.

12. The process of claim 11, further comprising determining whether the concentration of the one or more components in the net stream indicates the presence of a contaminant in the net stream.

13. The process of claim 12, wherein determining whether the concentration of the one or more components indicates the presence of a contaminant in the net stream includes determining whether the concentration of one or more components is above a predetermined threshold level.

14. The process of claim 12, wherein determining whether the concentration of the one or more components indicates the presence of a contaminant in the net stream includes determining whether the concentration of one or more components is below a predetermined threshold level.

15. The process of claim 12, further comprising determining whether the concentration of the one or more components in the net stream indicates the presence of a contaminant in the trackline stream in direct fluid communication therewith.

16. The process of claim 11, wherein the net stream comprises at least one of a net raffinate stream and the net extract stream.

17. The process of claim 11, further comprising irradiating another net stream of the rotary valve with laser light that is directed from another probe of the Raman system positioned for inline sampling of the other net stream;
collecting scattered light from the irradiated other net stream with the other probe;
analyzing the scattered light with the Raman system to assess concentrations of one or more components in the other net stream; and
comparing the concentrations of the one or more components in the net stream with the concentrations of the one or more components in the other net stream to identify a source of contamination.

18. The process of claim 11, further comprising irradiating at least one of a pusharound stream and a pumparound stream of the simulated moving bed system with laser light that is directed from another probe of the Raman system positioned for inline sampling of the at least one of the pusharound stream and the pumparound stream;
collecting scattered light from the irradiated at least one of the pusharound stream and the pumparound stream with the other probe; and
analyzing the scattered light with the Raman system to assess concentrations of one or more components in the at least of the pusharound stream and the pumparound stream.

19. The process according to claim 11, wherein the concentration of the one or more components is determined by generating a spectrum and determining the concentrations of the one or more components according to an algorithm correlating the concentrations to the spectrum.
